(19) United States
(12) Patent Application Publication
(10) Pub. No.: US 2007/0038996 A1
(43) Pub. Date: Feb. 15, 2007

(54) Remote I/O for virtualized systems

(75) Inventors: Shmuel Ben-Yehuda, Haifa (IL); Dhruv Desai, Cary, NC (US); Oleg Goldshmidt, Herzeliya (IL); Orran Y. Krieger, Newton, MA (US); Zorik Machulsky, Gesher HaZiv (IL); Vadim Makhervaks, Austin, TX (US); Julian Satran, Atlit (IL); Leah Shalev, Zichron Yaakov (IL); Ilan Shimony, Haifa (IL)

Correspondence Address: Stephen C. Kaufman;IBM CORPORATION, Intellectual Property Law Dept, P.O. Box 218, Yorktown Heights, NY, 10598, US

(73) Assignee: International Business Machines Corporation, Armonk, NY (US)

(21) Appl. No.: 11/199,765

(22) Filed: Aug. 9, 2005

(51) Int. Cl. G06F 9/455

(52) U.S. Cl. 718/1

(57) ABSTRACT

A virtualized system including a processing sub-system including a plurality of partitions and operating systems and a virtualization layer, each partition running its own operating system and having assigned its own partition ID, and an I/O emulation entity connected to the processing sub-system through a bus and connected to a network to which is connected at least one computer that hosts at least one remote I/O peripheral, the I/O emulation entity being adapted to execute an I/O-emulation transaction for any of the operating systems in accordance with that operating system's partition-ID.

### FIELD OF THE INVENTION

The present invention relates generally to virtualized systems, and more particularly to such a system wherein an I/O emulation entity connects through a network to remote I/O peripherals.

### BACKGROUND OF THE INVENTION

It is well known in the art to use virtualization to run multiple operating systems each one on its own virtual machine (VM), also called “partition”, each separate operating system (OS) having the illusion of running alone on the hardware platform. Many virtualized systems use a hypervisor, which oversees and supervises different aspects and functions of the virtualization. There are many kinds of virtualized systems that support the concurrent execution of multiple operating systems. Current solutions range from full virtualization to para-virtualization. In full virtualization the OS is not aware of the underlying virtualization layer which emulates the hardware completely. An example of such a solution is VMware, which supports multiple guest operating systems.

Another solution, para-virtualization, requires the OS to be aware of the hypervisor and the underlying machine abstraction layer. An example of such a solution is Xen, which is Open Source software that supports execution of multiple guest operating systems.

Reference is now made to FIG. 1, which illustrates a prior art virtualized system. The system typically includes a processing sub-system 10 that interfaces with an I/O (input/output) sub-system 12. The processing sub-system 10 typically includes a plurality of operating systems (OS) 14 that interface with a hosting partition 16 and a virtualization layer 18. The virtual I/O sub-system 12 typically includes a variety of I/O devices, such as but not limited to, keyboard, mouse, video (e.g., video editor, video converter, video display adaptor, for example, a VGA card), mass storage device (e.g., flash memory, storage devices such as IDE (integrated drive electronics) hard drives, SCSI (small computer system interface) hard drives, CD-ROM), or a network interface. Most microprocessor-based architectures revolve around the PCI (peripheral component interconnect) family of busses, which uses physical addresses and has no idea of and nothing to do with memory/IO space virtualization or protection. All the I/O between the processing sub-system 10 and the I/O sub-system 12 is handled by the hosting partition 16. This arrangement overburdens the CPU resources, since translation table setups are needed before I/O transactions.

Reference is now made to FIG. 2, which illustrates another prior art virtualized system. In this system, a hardware entity virtualizes the I/O devices. An OS accesses an I/O device through an “I/O virtualizer”. The I/O virtualizer verifies that the OS is allowed to access the device, and hides the fact that other OS's are also allowed to access that device. In the opposite direction, from I/O device to OS, the I/O virtualizer makes sure that only a permitted memory is accessed by the device. As in FIG. 1, each OS “thinks” it has the full system to itself.

### SUMMARY OF THE INVENTION

The present invention seeks to provide an improved virtualized system, as is described more in detail hereinbelow.

There is provided in accordance with a non-limiting embodiment of the invention a virtualized system including a processing sub-system including a plurality of partitions and operating systems and a virtualization layer, each partition running its own operating system and having assigned its own partition identifier (partition ID), and at least one I/O emulation entity connected to the processing sub-system through a bus and connected to a network to which is connected at least one computer that hosts at least one remote I/O peripheral, the at least one I/O emulation entity being adapted to execute an I/O-emulation transaction for any of the operating systems in accordance with that operating system's partition-ID. Further features are described hereinbelow.

### BRIEF DESCRIPTION OF THE DRAWINGS

The present invention will be understood and appreciated more fully from the following detailed description taken in conjunction with the appended drawings in which:

FIG. 1 is a simplified block diagram illustration of a prior art virtualized system with hosting partition and virtualization layer;

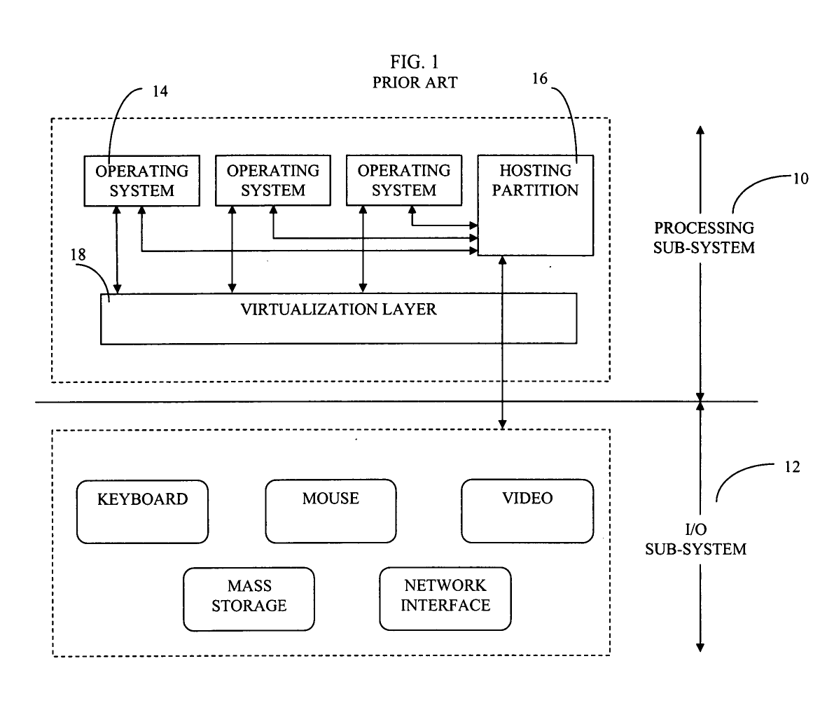

FIG. 2 is a simplified block diagram illustration of another prior art virtualized system; and

FIG. 3 is a simplified block diagram illustration of a virtualized system, in accordance with an embodiment of the present invention.

### DETAILED DESCRIPTION OF EMBODIMENTS

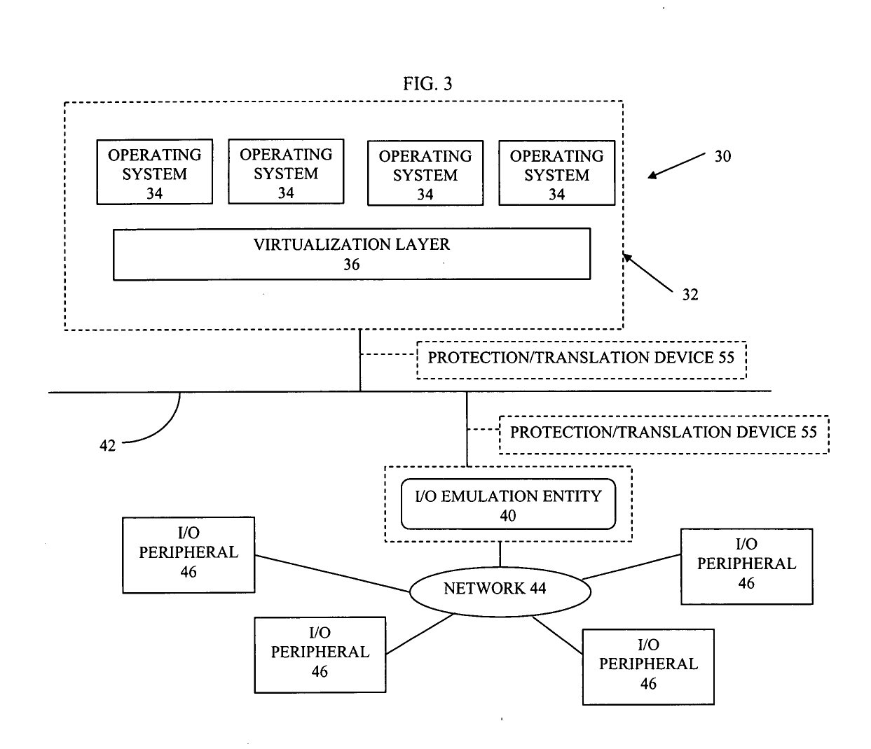

Reference is now made to FIG. 3, which illustrates a virtualized system 30, in accordance with an embodiment of the present invention.

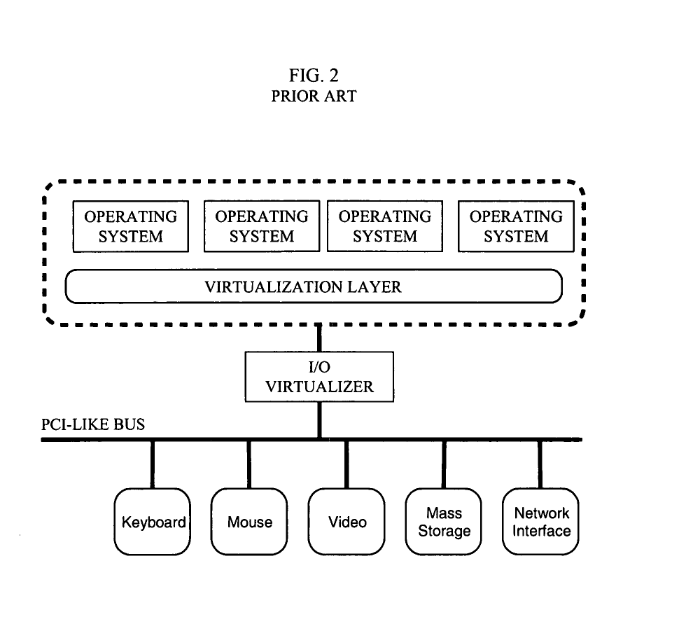

The virtualized system 30 may include a processing sub-system 32 that includes a plurality of operating systems (OS) 34 and a virtualization layer 36. Each operating system 34 is virtually partitioned from the other OS's by running in its own partition, and each OS is assigned its own partition identifier (partition ID). As opposed to the prior art solution of FIG. 2, in which all I/O devices are physically duplicated for each partition, in the present invention an I/O emulation entity 40 is provided, which may connect locally to (i.e., interfaces with) the processing sub-system 32 through a bus 42 (e.g., PCI bus or other suitable bus), and may connect (e.g., via Ethernet link) to a network, such as but not limited to, a LAN (local area network) 44. One or more computers 45, such as but not limited to, personal computers (PCs), management stations, file servers, laptops and many more, may be connected to the network 44. Each computer 45 may host one or more remote I/O peripherals 46. For example, a management station may host all of the system's remote graphics, or a file server may host disks for all partitions. Bus 42 can of course be shared with other systems, or shared with other OS's running on other partitions, and does not need to be dedicated to virtualized system 30. Each I/O peripheral 46 may connect to one or more partitions.

The way any of the operating systems 34 accesses its virtual I/O sub-system and performs a virtual I/O transaction is through the I/O emulation entity 40. The I/O transaction needs an associated partition-ID to access its virtual I/O sub-system. This ID may be supplied by the partition itself (i.e., by the operating system itself), by the virtualization layer 36, or inferred from the context of the I/O emulation transaction. The I/O emulation entity 40 executes an I/O-emulation transaction per partition, which has an associated partition-ID.

I/O emulation entity 40 may be implemented as a hardware device, or as a programmable device using its own CPU (central processing unit) or an external CPU, e.g., the main CPU, or a software product. For example, I/O emulation entity 40 may be software that performs (or a computer program product that includes instructions for) emulation of I/O transactions in the virtualized system 30, including but not limited to emulation of I/O transactions in any of virtual OS's 34. One non-limiting example of emulating I/O transactions in the virtualized system 30 may include recording the remote I/O address and any data provided in connection with accessing this address, providing the access address and data to a device emulator, analyzing the access address and data against pre-established information defining a plurality of operating modes of a remote I/O device to identify an intended operating mode of the remote I/O device, providing an emulation of the intended operating mode, and enabling the device emulator to carry out that emulation.

Protection and address translation tables can be added to virtualized system 30, thereby adding further flexibility in managing the system. For example, referring to FIG. 3, a protection/translation device 55 may be connected between the processing sub-system 32 and the bus 42. Such a protection/translation device 55 may comprise an IO-MMU (input/output memory management unit, which may convert physical addresses to I/O bus addresses. As another option, protection/translation device 55 may be located at the entrance to the I/O emulation entity 40, where it would serve just the emulation unit.

It is noted that in the prior art solution of FIG. 2 some or all I/O is carried out to local peripherals. In contrast, in the present invention, all I/O is performed remotely over the local area network. Each virtual OS 34 communicates with its I/O devices through the bus 42 and its standard, non-virtualized drivers, as it would do without virtualization. The drivers needed are those that are supported by the remote I/O emulation entity 40 (e.g., a standard VGA video driver).

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A virtualized system comprising:
a processing sub-system comprising a plurality of partitions and operating systems and a virtualization layer, each partition running its own operating system and having assigned its own partition identifier (partition ID); and
at least one I/O emulation entity connected to said processing sub-system through a bus and connected to a network to which is connected at least one computer that hosts at least one remote I/O peripheral, said at least one I/O emulation entity being adapted to execute an I/O-emulation transaction for any of the operating systems in accordance with that operating system's partition-ID.

2. The virtualized system according to claim 1, wherein said at least one remote I/O peripheral connects to at least one of said partitions.

3. The virtualized system according to claim 1, wherein said I/O emulation entity is implemented as a hardware device.

4. The virtualized system according to claim 1, wherein said I/O emulation entity is implemented as a programmable device using its own CPU (central processing unit).

5. The virtualized system according to claim 1, wherein said I/O emulation entity is implemented as a programmable device using an external CPU.

6. The virtualized system according to claim 1, wherein said I/O emulation entity is implemented as a software product.

7. The virtualized system according to claim 6, wherein said I/O emulation entity is implemented in any of said operating systems.

8. The virtualized system according to claim 1, wherein said network comprises a LAN (local area network).

9. The virtualized system according to claim 1, wherein the partition ID is defined by its operating system.

10. The virtualized system according to claim 1, wherein the partition ID is defined by said virtualization layer.

11. The virtualized system according to claim 1, wherein the partition ID is defined by a context of the I/O-emulation transaction.

12. A computer program product for use with a virtualized system, the virtualized system comprising a processing sub-system comprising a plurality of partitions and operating systems and a virtualization layer, each partition running its own operating system and having assigned its own partition ID, the computer program product comprising:
instructions for performing an I/O-emulation transaction between any of the operating systems of said processing sub-system and at least one remote I/O peripheral, in accordance with that operating system's partition-ID, wherein said computer program product interfaces with said processing sub-system through a bus and interfaces with a network to which is connected at least one computer that hosts at least one remote I/O peripheral.

13. The computer program product according to claim 12, wherein the partition ID is defined by its operating system.

14. The computer program product according to claim 12, wherein the partition ID is defined by said virtualization layer.

15. The computer program product according to claim 12, wherein the partition ID is defined by a context of the I/O-emulation transaction.

16. A method for managing a virtualized system comprising:
providing a processing sub-system comprising a plurality of partitions and operating systems and a virtualization layer, each partition running its own operating system and having assigned its own partition identifier (partition ID); and
providing an I/O emulation entity connected to said processing sub-system through a bus and connected to a network to which is connected at least one computer that hosts at least one remote I/O peripheral, said I/O emulation entity being adapted to execute an I/O-emulation transaction for any of the operating systems in accordance with that operating system's partition-ID.

17. The method according to claim 16, further comprising executing an I/O-emulation transaction for any of the operating systems in accordance with that operating system's partition-ID.

18. The method according to claim 16, further comprising implementing said I/O emulation entity as a hardware device.

19. The method according to claim 16, further comprising implementing said I/O emulation entity as a programmable device using its own CPU.

20. The method according to claim 16, further comprising implementing said I/O emulation entity as a programmable device using an external CPU.
